(19) United States
(12) Patent Application Publication
(10) Pub. No.: US 2004/0115317 A1
(43) Pub. Date: Jun. 17, 2004

(54) Method for opening sealed containers for foodstuff products

(76) Inventor: Luca Majer Doglioni, Milano (IT)

Correspondence Address: NIXON & VANDERHYE, PC, 1100 N GLEBE ROAD, 8TH FLOOR, ARLINGTON, VA, 22201-4714, US

(21) Appl. No.: 10/474,007

(22) PCT Filed: Mar. 29, 2002
(86) PCT No.: PCT/IB02/01019

(30) Foreign Application Priority Data
Apr. 6, 2001 (IT) MI2001A000741

(51) Int. Cl. A23B 4/00

(52) U.S. Cl. 426/123

(57) ABSTRACT

Method for opening a sealed container having a foodstuff therein, wherein the container comprises a plurality of walls, at least one of which can be perforated. At least one of the walls is opened from the inside towards the outside. It is also disclosed a sealed container (10) for a foodstuff product, wherein the container comprise a plurality of walls (1, 2, 3) one of which (2) at least can be perforated from the inside towards the outside of the container (10).

### TECHNICAL FIELD OF THE INVENTION

The present invention relates to a method for opening sealed foodstuff containers and in particular a method for opening disposable cartridges containing, for instance, powder or ground products intended for the preparation of drinks such as coffee, tea or the like.

### BACKGROUND OF THE INVENTION

For the sake of clarity, reference will be explicitly made in the following to the specific realization of containers shaped as disposable cartridges for the preparation of drinks, being understood that the principles of the present invention may be applied to any type of sealed foodstuff containers to be opened to release the contents thereof, or to allow mixing with other products or substances, before or during the evacuation of the contents from the same container.

At present, disposable cartridges for the preparation of drinks are obtained from plastic materials, such as polyolefins (e.g. polypropylene and polyethylene and/or copolymers thereof) or coupled films of polyolefins and aluminium suitable for use in the alimentary field, and are provided with one or more holes obtained on at least a wall, for instance on the lid, to allow the inlet of pressurized water during the utilization. For this reason, cartridges are distributed in sealed packages, such as for instance the so-called “blisters”.

Thus, the cartridge is hermetically packaged between a pre-formed tray from plastic material and a foil from plastics or aluminium. The latter must be removed to allow the extraction of the cartridge and its utilization in special dispensing machines for the preparation of drinks.

However, such a solution is not easily suitable for the use of said known cartridges even in automatic drink dispensers. In fact, even if all the cartridges were removed from their package and loaded in the automatic dispenser, a fresh product (e.g. ground coffee) might deteriorate, and a soluble powder product might disperse or loose anyhow its characteristics in the time.

In any case, even if one should consider the normal utilization of the cartridges packaged with hand-loaded dispensers, the problem still remain of the package, that is a waste to be disposed off.

Therefore, the need is felt of providing a container, and more particularly a cartridge containing products for the preparation of drinks, that is easily adaptable to both automatic and hand-loaded dispensers.

Taking into account the known art, the problem remains of removing the hermetic seal of the cartridge only at the time of its actual use in a drink-preparation dispenser.

Sealed packaged cartridges are also known, that are to be perforated at the time of their utilization. However the perforation of a cartridge at the time of its utilization is carried out by means of one or more lances or piercing elements that penetrate the cartridge from the outside to the inside.

The breaking of the container walls or their perforation may cause the release of particles of said cartridge that precipitate in the inside of the container, mixing with the foodstuff. As a consequence, the provided drink may also be disagreeable and have a poorly appetizing aspect.

Therefore, object of the present invention is to overcome the aforesaid limits of the known art, by providing a new type of container and more particularly a new type of cartridge, as well as a method for opening the same.

Within this scope, an object of the present invention is to provide a method allowing to open a sealed container at the time of its actual utilization.

More particularly, object of the present invention is to provide a method allowing to couple the opening of the cartridge and the dispensing of the drink.

Another object of the present invention is to provide a cartridge for the preparation of drinks and a method allowing to open the same when using either an automatic dispenser or a hand-loaded dispenser for the preparation of drinks.

A further object of the present invention is to provide a disposable cartridge suitable to be sealed in a controlled atmosphere or vacuum-packed, without necessarily employing further cartridge packages.

Still a further object of the present invention is to provide a method and a disposable cartridge allowing to prevent, or at least to limit as much as possible, the possible release of cartridge particles during its opening.

### SUMMARY OF THE INVENTION

These objects are achieved by he present invention that relates to a method for opening a sealed container having a foodstuff therein, wherein the container comprises a plurality of walls, at least one of which can be perforated, characterized in that at least one of the walls opens from the inside towards the outside.

The invention also relates to a sealed container for a foodstuff product, wherein the container comprise a plurality of walls, one of which at least can be perforated, characterized in that at least one of the walls comprises one or more portions that can be perforated from the inside towards the outside of the container.

According to a particularly advantageous aspect of the invention, the opening of the wall from the inside towards the outside is made through means contained in said container.

These means internal to the container can be activated by a piercing element that perforates at least another one of the container walls, or they may be activated by a pressurized flow let in the container. Besides, these means internal to the container may advantageously comprise one or more ducts allowing the flow of a fluid in their inside.

In a particular embodiment of the invention, the container is made up by a disposable cartridge sealed in a controlled atmosphere or vacuum-packed, that comprises at least a first pierceable wall, to allow a fluid to be let into the same, and at least a second pierceable wall, to allow the evacuation of a drink composed by the fluid and a suspension of a soluble foodstuff product.

According to another embodiment of the invention, the container is made up by a disposable cartridge, sealed in a controlled atmosphere or vacuum-packed, that comprises at least a first pierceable wall, to allow a fluid to be let into the same, and at least a second pierceable wall, to allow the evacuation of a drink obtained by filtration of the fluid through a fresh ground foodstuff product.

### BRIEF DESCRIPTION OF THE DRAWINGS

Further characteristics and advantages of the present invention will be more evident thanks to the following description reported by way of non limiting example with reference to the attached schematic drawings, wherein:

FIG. 1 is a section view of a cartridge intended for containing products for the preparation of drinks according to a possible embodiment of the present invention;

FIGS. 2A and 2B are plan views of some possible configurations of the breaking lines of a cartridge realized according to the present invention;

FIGS. 3A and 3B are elevation section views of some possible embodiments of the cartridge opening systems of the present invention;

FIG. 4 is a section view of another embodiment of a cartridge according to the present invention:

FIG. 5 is an elevation section view of an opening system of the cartridge shown in FIG. 4;

FIGS. 6 to 8 show some details of a cartridge and a system for the opening of the same according to an embodiment of the invention wherein the cartridge content is a ground product; and

FIGS. 9 and 10 show a cartridge realized in the same manner as the system of FIGS. 6 to 8, but intended for containing soluble products.

### MODES FOR CARRYING OUT THE INVENTION

Cartridge 10 shown in FIG. 1 essentially comprises a side wall 1, an upper wall 2 and a lower wall 3.

Walls 2 and 3 can be perforated in correspondence of the respective breaking lines 4 an 5 that are aligned with respect to axis 6 of the cartridge. The type of cartridge shown in FIG. 1 is especially suitable for soluble products.

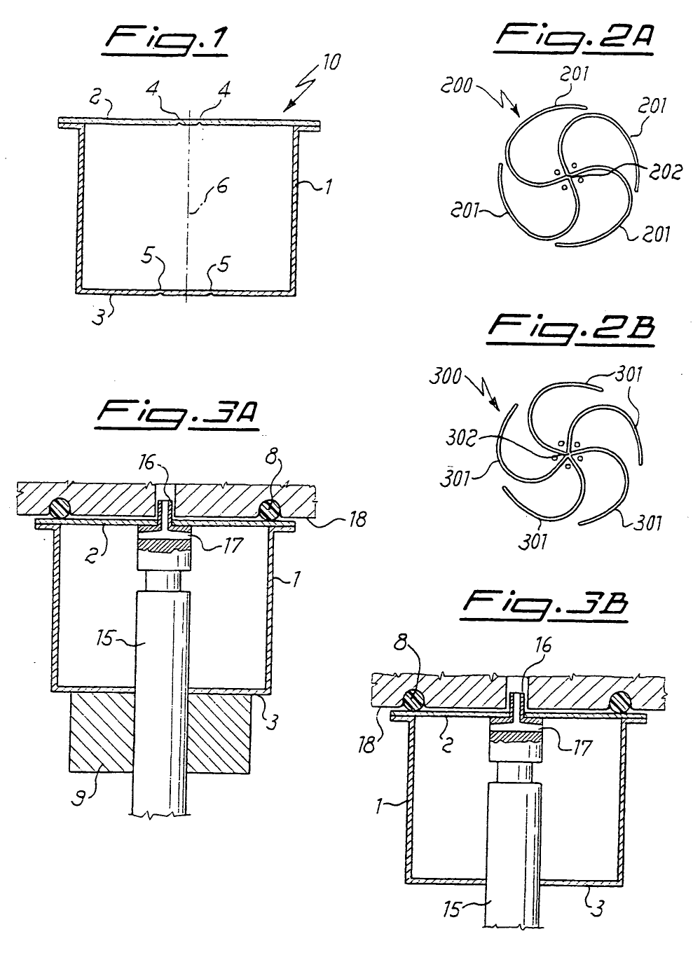

While the breaking lines 4 and 5 may be realized in this case according to any configuration, the adoption of breaking lines like the ones shown, for instance, in configurations 200 and 300 of the respective FIGS. 2A and 2B is particularly advantageous.

The breaking lines 201 and 301 are developed according to a polar sequence that bridges in the figures a whole round angle around a central point, indicated by 202 in FIG. 2A, respectively 302 in FIG. 2B, belonging in the trajectory of the piercing element.

These configurations of the breaking lines allow to optimise the container opening process thanks to the gradual breaking along said breaking lines, with a distribution of the tearing strength from the point where the detachment of the parts starts, which needs not to exactly coincide with the central point towards the periphery along the respective breaking lines. These configurations have the function of limiting as much as possible the fragmentation of the breaking profile, with the ensuing release of particles of the material which the container is made up from.

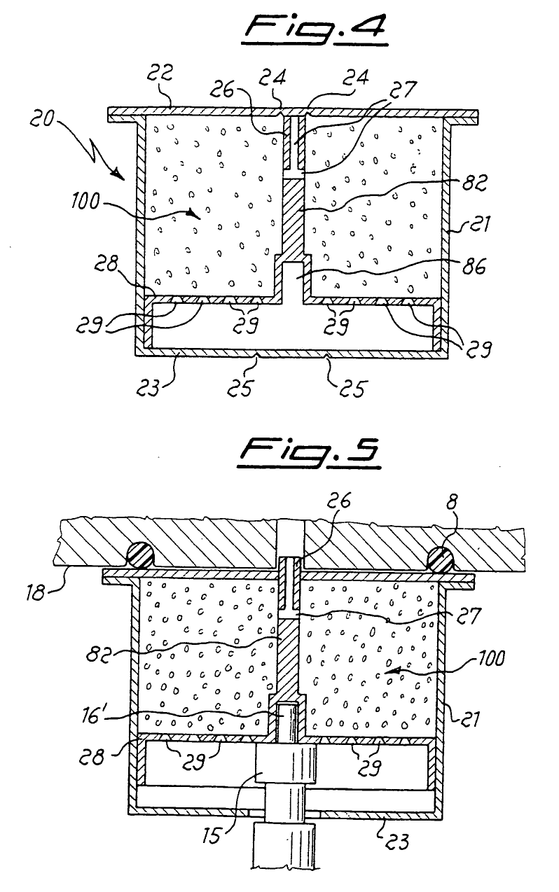

FIGS. 3A and 3B show some examples of the opening of the cartridge shown in FIG. 1. With respect to the opening systems of the known containers, these systems allow to perforate cartridge 1 not only on the bottom wall 3 in order to ensure the delivery of the drink made up by a suspension fluid (e.g. water) and the soluble product contained in the cartridge, but also on the upper wall 2, so that the suspension fluid can be let in.

In the systems of FIGS. 3A and 3B, a piercing element 15 is provided suitable to entirely perforate firstly the wall 3 of the cartridge, from the outside towards the inside, and afterwards wall 2, or lid, from the inside towards the outside.

The piercing element 15 is provided with an end 16 that can perforate the upper wall 2 of cartridge 1, with a set of ducts 17 intended for putting in fluid communication the inside of cartridge 1 with a pressurized fluid, for instance water at a suitable temperature, coming from the dispensing plate 18 abutting against the upper wall 2 of the cartridge.

A gasket 8 engaged in a special seat of plate 18 may be included to ensure the seal between plate 18 and the upper wall 2 of cartridge 1. In this manner, it is possible to combine the cartridge opening system with the drink dispensing system.

In the embodiment of the opening system of FIG. 3A, a supporting element 9 is included that bears the bottom wall 3 of cartridge 1. This solution is efficaciously suitable for use in dispensing drinks obtained from high water-solubility products.

With low solubility products it is also possible to utilize an opening and dispensing system having no cartridge-supporting elements, as shown in FIG. 3B.

Advantageously, cartridge 20 shown in FIG. 4 comprises means contained in the inside of said cartridge that allow to perforate the upper wall 22 thereof. Cartridge 20 also comprises a side wall 21 and a lower wall 23.

As represented herein, cartridge 20 is suitable, for instance, for the preparation of drinks from fresh ground products, for instance coffee or the like, but it is worth stressing that simple modifications allow its use also for soluble products.

In this embodiment, cartridge 20 comprises in its inside a not fully compacted ground product 100, as well as an internal plunger 28 having a section of the same shape and size as that of cartridge 20. The upper wall of plunger 28 is provided with holes 29 to allow the flow of the drink obtained by filtration of pressure-heated water through product 100.

In the middle of plunger 28 a pin 82 is provided that extends along the whole height of cartridge 20, such that end 26 of pin 82 abuts internally against the upper wall 22 of cartridge 20 in correspondence of a breaking portion defined by indentations 24. In the same manner as the embodiment previously shown, a breaking portion is obtained on the lower wall 23 through indentations 25, such that both breaking portions are axially aligned with each other.

Besides, the upper end 26 of rod 82 is provided with a plurality of ducts 27 that allow to feed pressurized water in the inside of cartridge 20. Under rod 82 a seat 86 is obtained wherein end 16′ of the piercing element 15 engages.

In fact, as shown in FIG. 5, the opening of the lower wall 23 of cartridge 20 is made by a piercing element 15 which perforates wall 23 in correspondence of indentation 25 at the time when the dispensing plate 18, provided with gasket 8, is pressed against the upper wall 22 of cartridge 20.

End 16′ of the piercing element 15 abuts in seat 86 provided under plunger 28, pushing it upwards until it perforates the upper wall 22 of cartridge 20 in correspondence of indentations 24. In this way, besides allowing the almost simultaneous opening of walls 22 and 23, the ground product 100 contained in cartridge 20 is further compacted. Ducts 27 provided at the end 26 of rod 82 allow therefore to let in the inside of cartridge the pressurized water dispensed by plate 18.

FIGS. 6 to 8 show another embodiment of the opening system of a cartridge 30 intended for containing a fresh ground product. Also in this embodiment, means in the inside of the container are provided that perforate a cartridge wall.

More particularly, cartridge 30 comprises a plunger 38 including a lance 36 whose tip faces the lower wall 33 of cartridge 30, and which may possibly have a flow duct. When cartridge 30 is inserted under the dispensing plate 108 (FIG. 6), one or more lances 106, associated to said plate and provided with ducts for letting pressurized water in, perforate the upper wall 32 of cartridge 30.

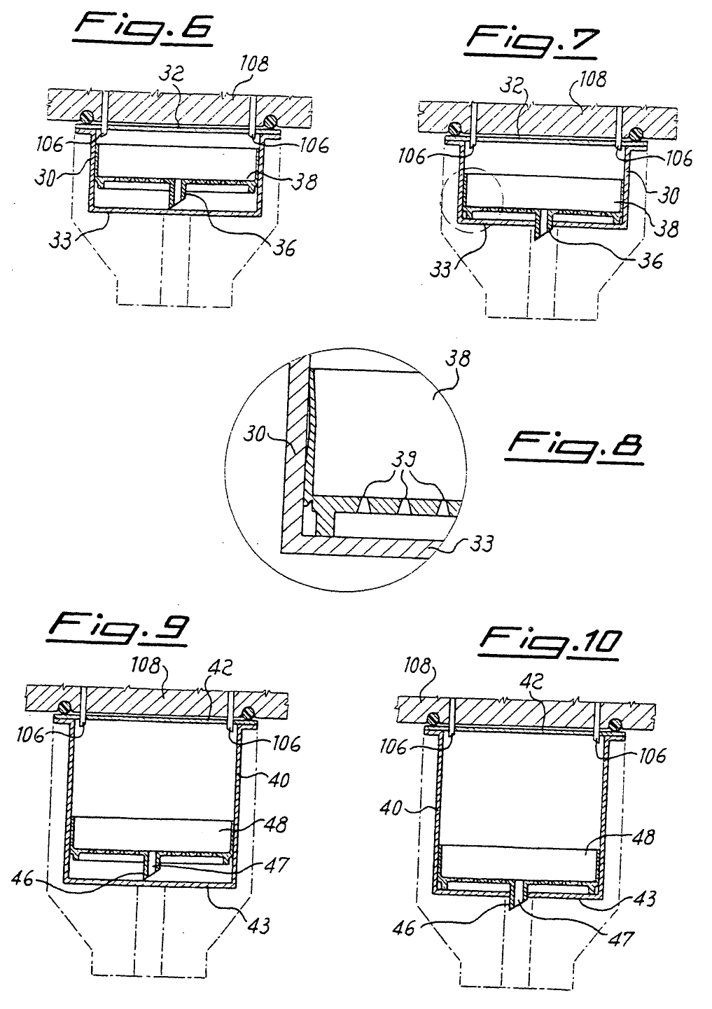

As soon as water is let into the inside of the cartridge, the pressure exercised by water let in through lances 106 and the compacted product contained in the inside of the cartridge push plunger 38 downwards until it perforates the lower wall 33 by means of lance 36 (FIG. 7).

The drink may be therefore dispensed through holes 39 (enlarged view of a detail of FIG. 8) obtained in the wall of plunger 38, as well as through the internal duct of lance 36, should this be provided for.

The same principle described with reference to FIGS. 6 to 8 for ground products intended for the processes of dispensing by filtration may also be used for the opening and the dispensing of soluble products.

In fact, as is shown in FIGS. 9 and 10, a cartridge 40 for soluble products contains in its inside a plunger 48 having a lance 46 whose tip is oriented towards the lower wall 43 of cartridge 40. In this case, lance 46 is necessarily provided with at least a duct 47 to allow the evacuation of the drink.

Also in this case, the opening of the upper wall 42 of cartridge 40 takes place through the lowering of the dispensing plate 108 on cartridge 40, whereby lances 106 perforate wall 42 to allow pressurized water to be let into the inside of cartridge (FIG. 9).

The pressure exercised by water let in cartridge 42 and the product contained therein lowers plunger 48 until the latter causes the perforation of the lower wall 43 by lance 46.

The opening systems and the cartridges shown in FIGS. 6 to 10 offer a better cleanness of the dispensing machine as they allow to expel upon each dispensing operation, both the cartridge lacerated part and the perforated part.

The cartridges according to the present invention may be realized with the common plastic products already known and utilized by the known art, for instance polyolefins (e.g. polypropylene and polyethylene and/or copolymers thereof), or with coupled films from polyolefins and aluminium suitable for use in the alimentary field, according to the requirements of each particular application.

1. A method for opening a sealed container having a foodstuff product therein, wherein said container comprises a plurality of walls, at least one of which is pierceable, characterized in that at least one of said walls is opened from the inside towards the outside.

2. A method according to claim 1, wherein the opening of said at least one wall of said container is realized through a piercing element that perforates said at least one wall from the inside towards the outside, upon perforation of another of said walls from the outside towards the inside.

3. A method according to claim 1, wherein the opening of said at least one wall from the inside towards the outside of said container is realized through means contained in said container.

4. A method according to claim 3, wherein said means for opening said at least one wall from the inside towards the outside are activated by a piercing element that perforates at least another one of the walls of said container.

5. A method according to claim 3, wherein said means for opening said at least one wall from the inside towards the outside are activated by a pressurized fluid let in said container.

6. A method according to any of the preceding claims, wherein said container is a disposable cartridge containing foodstuff for the preparation of drinks.

7. A method according to any of the preceding claims, wherein said container is a disposable cartridge sealed in a controlled atmosphere or vacuum-packed, comprising at least a first pierceable wall to allow a fluid to be let in the inside of the same and at least a second pierceable wall to allow the evacuation of a drink made up by said fluid and a suspension of a soluble foodstuff.

8. A method according to any of claims 1 through 6, wherein said container is a disposable cartridge sealed in a controlled atmosphere or vacuum-packed, comprising at least a first pierceable wall to allow a fluid to be let in the inside of the same and at least a second pierceable wall to allow the evacuation of a drink obtained by filtration of said fluid through a fresh ground foodstuff.

9. A sealed container for a foodstuff product, comprising a plurality of walls, at least one of which is pierceable, characterized in that at least one of said walls comprises one or more portions pierceable from the inside towards the outside of the container.

10. A container according to claim 9, wherein said at least one wall comprises at least a breaking portion axially aligned with another breaking portion obtained on another of said walls to allow a piercing element to perforate said at least one wall from the inside towards the outside upon perforation of the other of said walls from the outside towards the inside.

11. A container according to claim 9 or 10, wherein internal means are provided to open said at least one wall from the inside towards the outside.

12. A container according to claim 11, wherein said internal means for opening said at least one wall from the inside towards the outside are activated by a piercing element that perforates at least another wall of said container.

13. A container according to claim 11, wherein said internal means for opening said at least one wall from the inside towards the outside are activated by the pressure of a fluid let in said container and the product present therein.

14. A container according to any of claims 11 through 13, wherein said internal means for opening said at least one wall comprise one or more ducts to allow a fluid to flow in their inside.

15. A container according to any of claims 9 through 14, characterized by consisting of a disposable sealed cartridge containing a foodstuff product for the preparation of drinks.

16. A container according to any of claims 9 through 15, characterized by consisting of a disposable sealed cartridge comprising at least a first pierceable wall, to allow a fluid to be let into the inside of the same, and at least a second pierceable wall to allow the evacuation of a drink made up by said fluid and a suspension of a soluble foodstuff product.

17. A container according to any of claims 9 through 15, characterized by consisting of a disposable sealed cartridge comprising at least a first pierceable wall, to allow a fluid to be let into the inside of the same, and at least a second pierceable wall to allow the evacuation of a drink obtained by filtration of said fluid through a powder foodstuff product.
